(19) United States
(12) Patent Application Publication
(10) Pub. No.: US 2016/0342037 A1
(43) Pub. Date: Nov. 24, 2016

(54) LIQUID CRYSTAL DISPLAY PANEL AND MANUFACTURING METHOD THEREOF

(71) Applicant: SHENZHEN CHINA STAR OPTOELECTRONICS TECHNOLOGY CO., LTD., Shenzhen, Guandong (CN)

(72) Inventors: Cong WANG, Shenzhen, Guangdong (CN); Caiqin CHEN, Shenzhen, Guangdong (CN)

(21) Appl. No.: 14/652,794

(22) PCT Filed: Jan. 23, 2015
(86) PCT No.: PCT/CN2015/071422

§ 371 Date: Jun. 17, 2015

(30) Foreign Application Priority Data
Jan. 21, 2015 (CN) 201510030357.9

(51) Int. Cl. G02F 1/1343; G02F 1/1341; G02F 1/1335; G02F 1/1362; G02F 1/1368

(52) U.S. Cl. CPC G02F 1/134309; G02F 1/13624; G02F 1/1368; G02F 1/136286; G02F 1/133512; G02F 1/1341; G02F 2001/136222; G02F 2201/123; G02F 2201/121; G02F 2201/40; G02F 2001/134345

(57) ABSTRACT

A liquid crystal display panel and a manufacturing method thereof are provided. The method comprises in a step of manufacturing the first substrate or the second substrate, a first distance is made greater than a second distance, wherein the first distance is a distance between the second transparent conductive layer and the first transparent conductive layer corresponding to the main pixel area, and the second distance is a distance between the second transparent conductive layer and the first transparent conductive layer corresponding to the sub pixel area.

### FIELD OF THE INVENTION

The present invention relates to a technological field of liquid crystal displays, and more particularly to a liquid crystal display panel and a manufacturing method thereof.

### BACKGROUND OF THE INVENTION

A color filter on array (COA) technology directly manufactures a color resist layer on an array substrate, so as to effectively increase the arranging position precision of the array substrate and the color filter, and to save the money that would be spent on buying another color filter. Additionally, since the thickness of the color resist layer is greater than the thickness of the array substrate, this technology can reduce parasitic capacitors, so as to effectively decrease an RC delay effect of products; therefore it is widely used in large-scale liquid crystal products.

In a vertically aligned mode of large-scale liquid crystal products, there is a serious chromatic aberration phenomenon. For improving the chromatic aberration phenomenon, a traditional method is to change electric properties, namely each pixel unit is divided into a main pixel area and a sub pixel area. Therefore, a thin film transistor and a sharing capacitor are necessary to be added in the traditional method, wherein the thin film transistor is used to control switching on/off of the sharing capacitor, so that the voltage of a liquid crystal capacitor of the sub pixel area is lowered by the sharing capacitor, so as to solve a chromatic aberration problem when seen from a large viewing angle. However, since the above-mentioned thin film transistor and sharing capacitor will shade a larger portion of lights of the pixel unit, the aperture ratio of the pixel unit will be reduced.

Hence, it is necessary to provide a liquid crystal display panel and a manufacturing method thereof which solves the problems existing in the conventional technologies.

### SUMMARY OF THE INVENTION

The object of the present invention is to provide a liquid crystal display panel and a manufacturing method thereof, so as to solve a technical problem of reducing the aperture ratio of a pixel when solving the chromatic aberration problem when seen from a large viewing angle.

For solving the above-mentioned technical problems, the present invention constructs a manufacturing method of a liquid crystal display panel, wherein the liquid crystal display panel comprises a first substrate, a second substrate, and a liquid crystal layer between the first substrate and the second substrate; the first substrate comprises a first transparent conductive layer; the second substrate comprises a switch array layer, a color resist layer, and a second transparent conductive layer; the color resist layer comprises a plurality of pixel units; and each of the pixel units comprises a main pixel area and a sub pixel area, and

the method comprises:

manufacturing the first substrate;

manufacturing the second substrate, wherein the second substrate is disposed opposite the first substrate; and

injecting a liquid crystal between the first substrate and the second substrate;

wherein in the step of manufacturing the first substrate, a first distance is made greater than a second distance, and this step comprises:

forming a black matrix layer on a substrate;

forming a planar layer on the black matrix layer;

patterning the planar layer, such that the thickness of the planar layer corresponding to the main pixel area less than the thickness of the planar layer corresponding to the sub pixel area; and

forming a first transparent conductive layer on the patterned planar layer;

wherein the first distance is a distance between the second transparent conductive layer and the first transparent conductive layer corresponding to the main pixel area; and the second distance is a distance between the second transparent conductive layer and the first transparent conductive layer corresponding to the sub pixel area; and

the second substrate comprises a plurality of data lines and a plurality of scan lines; and each of the pixel units is correspondingly provided with one scan line.

In the manufacturing method of the liquid crystal display panel according to the present invention, the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

In the manufacturing method of the liquid crystal display panel according to the present invention, the color resist layer is positioned on the switch array layer.

In the manufacturing method of the liquid crystal display panel according to the present invention, the second substrate is a color filter on array (COA) substrate.

The present invention constructs a manufacturing method of a liquid crystal display panel, wherein the liquid crystal display panel comprises a first substrate, a second substrate, and a liquid crystal layer between the first substrate and the second substrate; the first substrate comprises a first transparent conductive layer; the second substrate comprises a switch array layer, a color resist layer, and a second transparent conductive layer; the color resist layer comprises a plurality of pixel units; and each of the pixel units comprises a main pixel area and a sub pixel area, and

the method comprises:

manufacturing the first substrate;

manufacturing the second substrate, wherein the second substrate is disposed opposite the first substrate; and

injecting a liquid crystal between the first substrate and the second substrate;

wherein in the step of manufacturing the first substrate or the second substrate, a first distance is made greater than a second distance; wherein the first distance is a distance between the second transparent conductive layer and the first transparent conductive layer corresponding to the main pixel area; and the second distance is a distance between the second transparent conductive layer and the first transparent conductive layer corresponding to the sub pixel area.

In the manufacturing method of the liquid crystal display panel according to the present invention, in the step of manufacturing the first substrate, the first distance is made greater than the second distance, and the step comprises:

forming a black matrix layer on a substrate;

forming a planar layer on the black matrix layer;

patterning the planar layer, such that the thickness of the planar layer corresponding to the main pixel area less than the thickness of the planar layer corresponding to the sub pixel area; and

forming a first transparent conductive layer on the patterned planar layer.

In the manufacturing method of the liquid crystal display panel according to the present invention, the second substrate comprises a plurality of data lines and a plurality of scan lines; and each of the pixel units is correspondingly provided with one scan line.

In the manufacturing method of the liquid crystal display panel according to the present invention, the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

In the manufacturing method of the liquid crystal display panel according to the present invention, the color resist layer is positioned on the switch array layer.

In the manufacturing method of the liquid crystal display panel according to the present invention, the second substrate is a COA substrate.

The present invention further provides a liquid crystal display panel, which comprises:

a first substrate comprising a black matrix layer, a planar layer, and a first transparent conductive layer;

a second substrate disposed opposite the first substrate and comprising a switch array layer, a color resist layer, and a second transparent conductive layer, wherein the color resist layer comprises a plurality of pixel units, and each of the pixel units comprises a main pixel area and a sub pixel area; and

a liquid crystal layer positioned between the first substrate and the second substrate;

wherein the first distance is a distance between the second transparent conductive layer and the first transparent conductive layer corresponding to the main pixel area; and the second distance is a distance between the second transparent conductive layer and the first transparent conductive layer corresponding to the sub pixel area.

In the liquid crystal display panel according to the present invention, the planar layer comprises a first portion and a second portion; the thickness of the first portion is less than the thickness of the second portion; wherein the first portion is corresponding to the position of the main pixel area, and the second portion is corresponding to the position of the sub pixel area; and

the first transparent conductive layer is positioned on the planar layer

In the liquid crystal display panel according to the present invention, the second substrate comprises a plurality of data lines and a plurality of scan lines; and each of the pixel units is correspondingly provided with one scan line.

In the liquid crystal display panel according to the present invention, the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

In the liquid crystal display panel according to the present invention, the color resist layer is positioned on the switch array layer.

In the liquid crystal display panel according to the present invention, the second substrate is a COA substrate.

The liquid crystal display panel according to the present invention and the manufacturing method thereof can solve the chromatic aberration problem which occurs when seen from a large viewing angle and increase the aperture ratio of the pixel, so as to improve the display effect of the liquid crystal display.

### DESCRIPTION OF THE DRAWINGS

FIG. 1 is a structural schematic view of a liquid crystal display panel according to a conventional technology;

FIG. 2 is a structural schematic view of a pixel unit according to the conventional technology;

FIG. 3 is a structural schematic view of a circuit of the pixel unit according to the conventional technology;

FIG. 4 is a structural schematic view of a liquid crystal display panel according to a preferred embodiment of the present invention;

FIG. 5 is a structural schematic view of a pixel unit according to the preferred embodiment of the present invention; and

FIG. 6 is a structural schematic view of a circuit of the pixel unit according to the preferred embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto. In the drawings, units with similar structures use the same numerals.

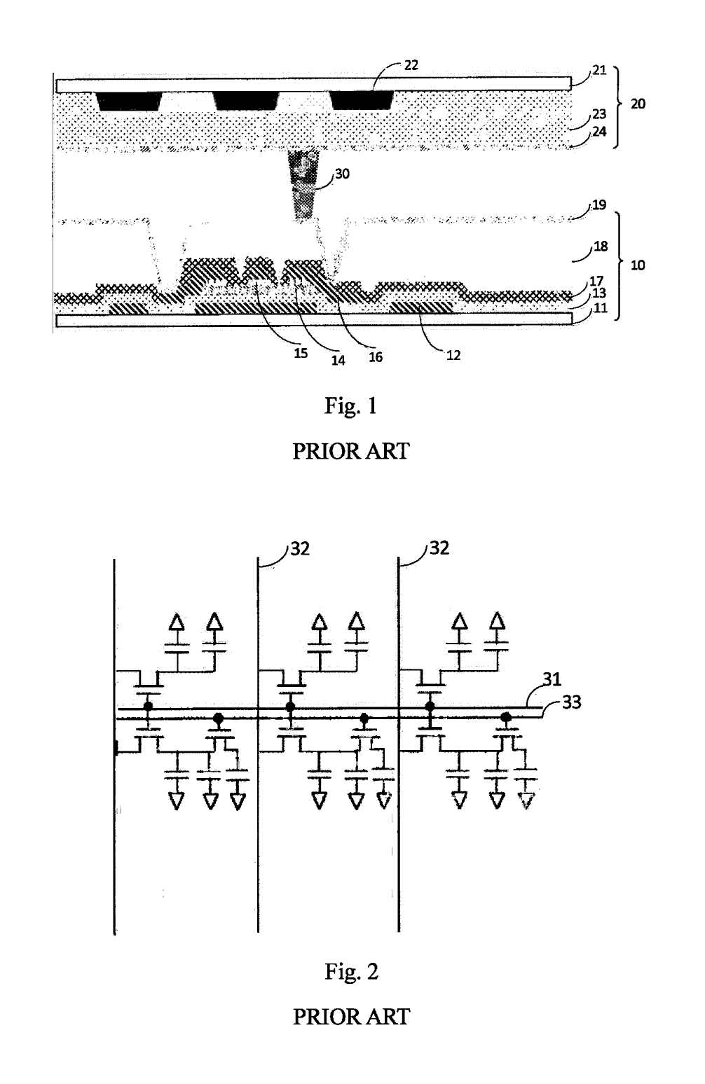

Refer now to FIG. 1, which is a structural schematic view of a liquid crystal display panel according to a conventional technology. The traditional liquid crystal display panel comprises a first substrate 20, a second substrate 10, a liquid crystal layer, and at least one spacer 30. The first substrate 20 comprises a substrate 21, a black matrix layer 22, a planar layer 23, and a first transparent conductive layer 24. The second substrate 10 is disposed opposite the first substrate 20. The second substrate 10 is a color filter on array (COA) substrate, which comprises a substrate 11, a switch array layer, a color resist layer 18, and a second transparent conductive layer 19. The switch array layer comprises a first metal layer 12, a gate insulation layer 13, an active layer 14, an ohmic contact layer 15, a second metal layer 16, and a first passivation layer 17. The color resist layer 18 comprises a plurality of pixel units, and each of the pixel units comprises a main pixel area and a sub pixel area.

Moreover, the liquid crystal layer is positioned between the first substrate and the second substrate; and the spacer 30 is used to maintain an interval between the first substrate 20 and the second substrate 10.

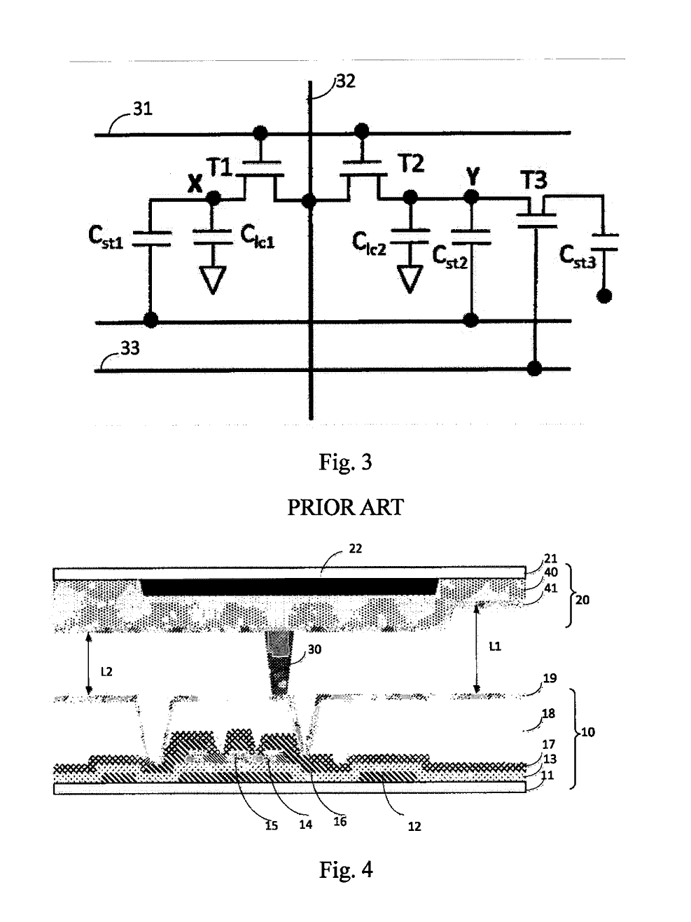

Refer now to FIGS. 2 and 3, each of the main pixel areas of the pixel units comprises a first thin film transistor, and each of the sub pixel areas of the pixel units comprises a second thin film transistor and a third thin film transistor, wherein a gate electrode of the first thin film transistor and a gate electrode of the second thin film transistor are connected with a main scan line; a drain electrode of the first thin film transistor is connected with a first liquid crystal capacitor and a first storage capacitor; a source electrode of the first thin film transistor and a source electrode of the second thin film transistor are connected with a data line; a drain electrode of the second thin film transistor is connected with a second liquid crystal capacitor, a second storage capacitor, and a source electrode of a third thin film transistor; a gate electrode of the third thin film transistor is connected with a sub scan line; a drain electrode of the third thin film transistor is connected with a sharing capacitor. The data line is numeral 32; the main scan line is numeral 31; and the sub scan line is numeral 33. There is a red pixel unit, a green pixel unit, and a blue pixel unit from the left to right side. Take the red pixel unit as an example, a main pixel area thereof comprises a first thin film transistor T1, and a sub pixel area thereof (a gray area in a lower portion of FIG. 2) comprises a second thin film transistor T2 and a third thin film transistor T3, wherein gate electrodes of the first thin film transistor T1 and the second thin film transistor T2 are connected with the main scan line 31, and a gate electrode of the third thin film transistor T3 is connected with the sub scan line 33.

In FIG. 3, numerals Clc1 and Clc2 respectively indicate liquid crystal capacitors of the main pixel area and the sub pixel area; numerals Cst1 and Cst2 respectively indicate storage capacitors of the main pixel area and the sub pixel area; numeral Cst3 indicates a sharing capacitor. If the input voltage of the data line is V0, when charging the pixel unit, the electric potential at a point X of the pixel electrode of the main pixel area is Formula 1:

VX=V0 Formula 1

The electric potential at a point Y of the pixel electrode of the sub pixel area is Formula 2:

$$VY = V 0 ( \frac{{C}_{2}}{{C}_{2} + 2 {C}_{st 3}} ) \qquad Formula 2$$

Wherein C2 is shown as Formula 3:

C₂=C_{st 2}+C_{l C2} Formula 3

The different value of the electric potential between the pixel electrodes of the main pixel area and the sub pixel area is as Formula 4:

$$Δ V = VX - VY = V 0 - V 0 ( \frac{{C}_{2}}{{C}_{2} + 2 {C}_{st 3}} ) = V 0 ( \frac{2 {C}_{st 3}}{{C}_{2} + 2 {C}_{st 3}} ) \qquad Formula 4$$

By changing the voltage value of the main pixel area and the sub pixel area, the brightness of the sub pixel area is less than the brightness of the main pixel area, so as to solve a chromatic aberration problem when seen from a large viewing angle. However, since the third thin film transistor and the sharing capacitor shade a larger portion of lights of whole of the pixel unit, the aperture ratio of the pixel unit will be reduced.

A liquid crystal display panel according to the present invention comprises a first substrate, a second substrate, a liquid crystal layer, and at least one spacer. The first substrate comprises a black matrix layer, a planar layer, and a first transparent conductive layer. The second substrate is disposed opposite the first substrate. It is possible for the second substrate to be a COA substrate, which comprises a switch array layer, a color resist layer, and a second transparent conductive layer. The color resist layer comprises a plurality of pixel units, and each of the pixel units comprises a main pixel area and a sub pixel area.

Moreover, the liquid crystal layer is positioned between the first substrate and the second substrate; and the spacer is used to maintain an interval between the first substrate and the second substrate.

The distance between the second transparent conductive layer and the first transparent conductive layer corresponding to the main pixel area is a first distance; and the distance between the second transparent conductive layer and the first transparent conductive layer corresponding to the sub pixel area is a second distance. The first distance is greater than the second distance.

A manufacturing method of the liquid crystal display panel according to the present invention comprises:

S101: manufacturing the first substrate.

The specific process is: forming a black matrix layer, a planar layer, and a first transparent conductive layer on a substrate in order, wherein the first transparent conductive layer comprises a common electrode. The black matrix layer is formed by exposing and developing a black matrix material which is coated on the substrate.

S102: manufacturing the second substrate, wherein the second substrate is disposed opposite the first substrate.

The specific process is: forming a first metal layer, a gate insulation layer, an active layer, an ohmic contact layer, a second metal layer, a first passivation layer, a color resist layer, and a second transparent conductive layer on another substrate, wherein the second transparent conductive layer comprises a pixel electrode.

S103: injecting a liquid crystal between the first substrate and the second substrate.

When in the process of manufacturing the first substrate or the second substrate, a first distance is made greater than a second distance, wherein the first distance is the distance between the second transparent conductive layer and the first transparent conductive layer corresponding to the main pixel area; and the second distance is the distance between the second transparent conductive layer and the first transparent conductive layer corresponding to the sub pixel area.

Since the penetrance rate of lights is related to distance, if a distance between two substrates is larger, the penetrance rate is larger. In the present invention, the distance between the two substrates corresponding to the main pixel area (the first distance) is greater than the distance between the two substrates corresponding to the sub pixel area (the second distance), so more light can pass through the main pixel area, namely the brightness of the main pixel area is greater than the brightness of the sub pixel area. Therefore, it is unnecessary to arrange a third thin film transistor and a sharing capacitor, thereby solving the chromatic aberration problem when seen from a large viewing angle. In the meantime, since the third thin film transistor and the sharing capacitor are saved, the aperture ratio of the pixel unit will be increased.

The liquid crystal display panel according to the present invention and the manufacturing method thereof can solve the chromatic aberration problem when seen from a large viewing angle and increase the aperture ratio of the pixel, so as to improve the display effect of the liquid crystal display.

Refer now to FIG. 4, which is a structural schematic view of a liquid crystal display panel according to a preferred embodiment of the present invention.

As shown in FIG. 4, the second substrate 10 further comprises a substrate 11, a first metal layer 12, a gate insulation layer 13, an active layer 14, an ohmic contact layer 15, a second metal layer 16, and a first passivation layer 17, a color resist layer 18, and a second transparent conductive layer 19, wherein the first metal layer 12, the gate insulation layer 13, the active layer 14, the ohmic contact layer 15, the second metal layer 16, and the first passivation layer 17 assemble a switch array layer, and the color resist layer 18 is positioned on the switch array layer.

The first substrate 20 further comprises a substrate 21, a black matrix layer 22, a planar layer 40, and a first transparent conductive layer 41. The planar layer 40 comprises a first portion and a second portion. The thickness of the first portion is less than the thickness of the second portion. The first portion is corresponding to the position of the main pixel area; and the second portion is corresponding to the position of the sub pixel area.

The first transparent conductive layer 41 is positioned on the planar layer 40.

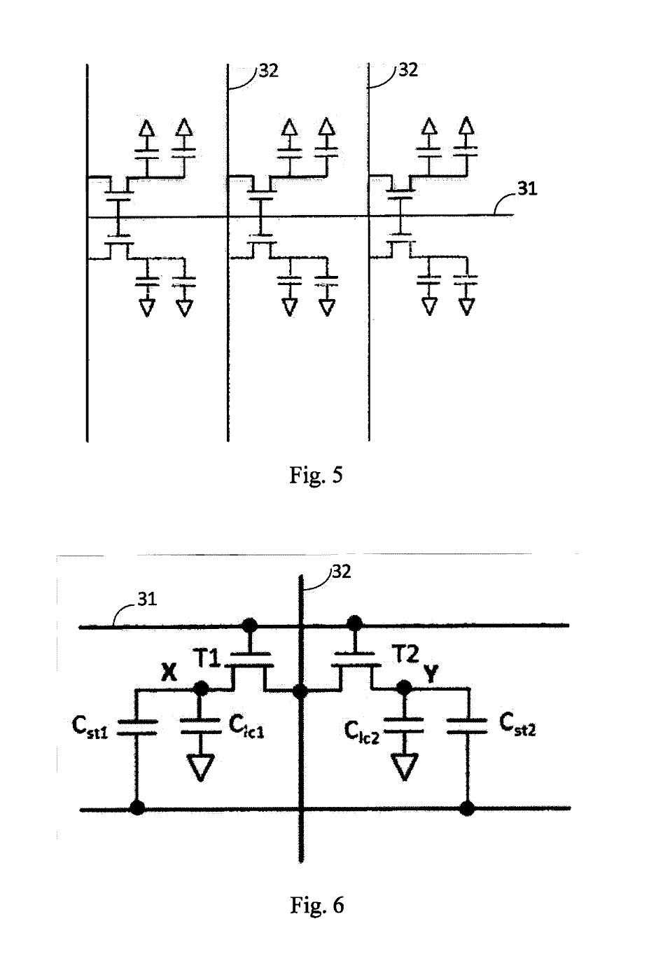

The second substrate comprises a plurality of data lines and a plurality of scan lines. As shown in FIG. 5, each of the pixel units is correspondingly provided with one scan line. Since in the conventional technology each of the pixel units is correspondingly provided with two scan lines, the present invention can further increase the aperture ratio of the pixel unit by decreasing one scan line (the sub scan line 33).

Refer now to FIGS. 5 and 6, the main pixel area of the pixel unit comprises a first thin film transistor T1, and the sub pixel area of the pixel unit comprises a second thin film transistor T2 (a third thin film transistor T3 and a sharing capacitor Cst3 are saved), wherein a gate electrode of the first thin film transistor T1 and a gate electrode of the second thin film transistor T2 are connected with the main scan line 31 corresponding to the pixel unit, and a source electrode of the first thin film transistor T1 and a source electrode of the second thin film transistor T2 are connected with the data line 32.

The difference between the manufacturing method of the liquid crystal display panel according to this preferred embodiment and the previous embodiment is that:

In this preferred embodiment of the present invention, the first distance L1 being greater than the second distance L2 is accomplished in the process of manufacturing the first substrate, and specific processes thereof comprises:

S201: forming a black matrix layer on a substrate.

The black matrix layer comprises a plurality of black matrixes. A material of the black matrix is coated on the substrate 21. It is possible for the substrate 21 to be a glass substrate. The material of the black matrix is an opaque negative photoresist material. Then a mask is used to expose and develop the black matrix material coated on the substrate 20, so as to form the plurality of the black matrixes. The black matrix layer comprises a plurality of the black matrixes.

S202: forming a planar layer on the black matrix layer.

It is possible for the material of the planar layer 40 to be a transparent acrylic acid resin, a polyimide resin, or a polyurethane resin. The planar layer 40 is used to protect the black matrixes and prevent the liquid crystal from contamination.

S203: patterning the planar layer. The specific process is:

S301: coating a photoresist material on the planar layer.

It is possible for the photoresist material to be a negative photoresist material or a positive photoresist material.

S302: exposing and developing the photoresist material by using a halftone mask.

For example, the photoresist material is a negative photoresist material. The halftone mask comprises a plurality of default pattern. The default pattern comprises all-light-pass areas and part-light-pass areas. The part-light-pass areas are corresponding to the position of the main pixel area; and the all-light-pass areas are corresponding to the position of the sub pixel area. Therefore, in the developing process, the photoresist material which corresponds to the main pixel area is easily developed, the photoresist material which does not correspond to the main pixel area is not developed, so as to form a photoresist layer.

S303: etching the planar layer uncovered by the photoresist layer and the photoresist layer on the planar layer.

The photoresist layer on the planar layer is corresponding to the sub pixel area, so that the planar layer uncovered by the photoresist layer is easier to be etched than the planar layer covered with the photoresist layer. Therefore, after the etching process, the thickness of the planar layer corresponding to the main pixel area is less than the thickness of the planar layer corresponding to the sub pixel area.

S304: cleaning the rest photoresist layer.

By cleaning the photoresist layer which is not etched in the step S303, the photoresist layer is removed.

S204: forming a first transparent conductive layer on the patterned planar layer.

The material of the first transparent conductive layer 41 is indium tin oxide, and the first transparent conductive layer 41 comprises a common electrode.

In the present invention, the first distance being greater than the second distance is accomplished in the manufacturing process of the first substrate. Since the structure of the first substrate is simpler, it is easily manufactured, and can reduce manufacturing cost. It should be understood, the first distance being greater than the second distance also can be accomplished in the manufacturing process of the second substrate.

By increasing the distance between the two substrates corresponding to the main pixel area, the liquid crystal display panel according to the present invention and the manufacturing method thereof can solve the chromatic aberration problem when seen from a large viewing angle and increase the aperture ratio of the pixel, so as to improve the display effect of the liquid crystal display.

The present invention has been described with preferred embodiments thereof and it is understood that many changes and modifications to the described embodiment can be carried out without departing from the scope and the spirit of the invention that is intended to be limited only by the appended claims.

1. A manufacturing method of a liquid crystal display panel, wherein the liquid crystal display panel comprises a first substrate, a second substrate, and a liquid crystal layer between the first substrate and the second substrate; the first substrate comprises a first transparent conductive layer; the second substrate comprises a switch array layer, a color resist layer, and a second transparent conductive layer; the color resist layer comprises a plurality of pixel units; and each of the pixel units comprises a main pixel area and a sub pixel area, and
the method comprises:
manufacturing the first substrate;
manufacturing the second substrate, wherein the second substrate is disposed opposite the first substrate; and
injecting a liquid crystal between the first substrate and the second substrate;
wherein in the step of manufacturing the first substrate, a first distance is made greater than a second distance, and this step comprises:
forming a black matrix layer on a substrate;
forming a planar layer on the black matrix layer;
patterning the planar layer, such that the thickness of the planar layer corresponding to the main pixel area less than the thickness of the planar layer corresponding to the sub pixel area; and
forming a first transparent conductive layer on the patterned planar layer;
wherein the first distance is a distance between the second transparent conductive layer and the first transparent conductive layer corresponding to the main pixel area; and the second distance is a distance between the second transparent conductive layer and the first transparent conductive layer corresponding to the sub pixel area; and
the second substrate comprises a plurality of data lines and a plurality of scan lines; and each of the pixel units is correspondingly provided with one scan line.

2. The manufacturing method of the liquid crystal display panel according to claim 1, wherein the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

3. The manufacturing method of the liquid crystal display panel according to claim 1, wherein the color resist layer is positioned on the switch array layer.

4. The manufacturing method of the liquid crystal display panel according to claim 1, wherein the second substrate is a color filter on array (COA) substrate.

5. A manufacturing method of a liquid crystal display panel, wherein the liquid crystal display panel comprises a first substrate, a second substrate, and a liquid crystal layer between the first substrate and the second substrate; the first substrate comprises a first transparent conductive layer; the second substrate comprises a switch array layer, a color resist layer, and a second transparent conductive layer; the color resist layer comprises a plurality of pixel units; and each of the pixel units comprises a main pixel area and a sub pixel area, and
the method comprises:
manufacturing the first substrate;
manufacturing the second substrate, wherein, the second substrate is disposed opposite the first substrate; and
injecting a liquid crystal between the first substrate and the second substrate;
wherein in the step of manufacturing the first substrate or the second substrate, a first distance is made greater than a second distance; wherein the first distance is a distance between the second transparent conductive layer and the first transparent conductive layer corresponding to the main pixel area; and the second distance is a distance between the second transparent conductive layer and the first transparent conductive layer corresponding to the sub pixel area.

6. The manufacturing method of the liquid crystal display panel according to claim 5, wherein in the step of manufacturing the first substrate, the first distance is made greater than the second distance, and the step comprises:
forming a black matrix layer on a substrate;
forming a planar layer on the black matrix layer;
patterning the planar layer, such that the thickness of the planar layer corresponding to the main pixel area less than the thickness of the planar layer corresponding to the sub pixel area; and
forming a first transparent conductive layer on the patterned planar layer.

7. The manufacturing method of the liquid crystal display panel according to claim 5, wherein the second substrate comprises a plurality of data lines and a plurality of scan lines; and each of the pixel units is correspondingly provided with one scan line.

8. The manufacturing method of the liquid crystal display panel according to claim 7, wherein the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

9. The manufacturing method of the liquid crystal display panel according to claim 5, wherein the color resist layer is positioned on the switch array layer.

10. The manufacturing method of the liquid crystal display panel according to claim 5, wherein the second substrate is a COA substrate.

11. A liquid crystal display panel, comprising:
a first substrate comprising a black matrix layer, a planar layer, and a first transparent conductive layer;
a second substrate disposed opposite the first substrate and comprising a switch array layer, a color resist layer, and a second transparent conductive layer, wherein the color resist layer comprises a plurality of pixel units, and each of the pixel units comprises a main pixel area and a sub pixel area; and
a liquid crystal layer positioned between the first substrate and the second substrate;
wherein the first distance is a distance between the second transparent conductive layer and the first transparent conductive layer corresponding to the main pixel area; and the second distance is a distance between the second transparent conductive layer and the first transparent conductive layer corresponding to the sub pixel area.

12. The liquid crystal display panel according to claim 11, wherein the planar layer comprises a first portion and a second portion; the thickness of the first portion is less than the thickness of the second portion; and wherein the first portion is corresponding to the position of the main pixel area, and the second portion is corresponding to the position of the sub pixel area; and
the first transparent conductive layer is positioned on the planar layer.

13. The liquid crystal display panel according to claim 11, wherein the second substrate comprises a plurality of data lines and a plurality of scan lines; and each of the pixel units is correspondingly provided with one scan line.

14. The liquid crystal display panel according to claim 13, wherein the main pixel area of the pixel unit comprises a first thin film transistor; the sub pixel area of the pixel unit comprises a second thin film transistor; and a gate electrode of the first thin film transistor and a gate electrode of the second thin film transistor are connected with the main scan line corresponding to the pixel unit.

15. The manufacturing method of the liquid crystal display panel according to claim 11, wherein the color resist layer is positioned on the switch array layer.

16. The manufacturing method of the liquid crystal display panel according to claim 11, wherein the second substrate is a COA substrate.
